(19) United States
(12) Patent Application Publication
(10) Pub. No.: US 2013/0320783 A1
(43) Pub. Date: Dec. 5, 2013

(54) STEP MOTOR ABLE TO ADJUST A HEADLIGHT'S UP AND DOWN

(71) Applicants: Hsiu-Ming Huang, Yong Kang (TW); Hsian-Yi Huang, Tainan (TW)

(72) Inventors: Hsiu-Ming Huang, Yong Kang (TW); Hsian-Yi Huang, Tainan (TW)

(21) Appl. No.: 13/487,257

(22) Filed: Jun. 4, 2012

(51) Int. Cl. H02K 37/24

(52) U.S. Cl. 310/48

(57) ABSTRACT

A step motor used to adjust a headlight's up and down includes a supporting pole, a magnet, a coil and a circuit board. The circuit board has a power input terminal subsequently connected with a voltage regulator IC, a control IC, a transistor and a driver. In addition, the driver is connected with the coil; the control IC is connected with a signal input terminal further connected with a vehicle compute; the power input terminal is connected with a vehicle power source. So when a vehicle is started, power can flow through and regulated by the voltage regulator IC. Then it runs through the control IC to command the driver to drive the negative coil to induce the magnet to rotate clockwise or counterclockwise, enabling the supporting pole to move inward or outward to horizontally balance the headlight.

### BACKGROUND OF THE INVENTION

1. Field of the Invention

This invention relates to a step motor able to adjust a vehicle head-light's up and down, particularly to one enabling power to orderly flow through a voltage regulator IC, a control IC and a driver to make a coil to induce a magnet to rotate clockwise or counterclockwise, so as to enable a supporting pole to move inward or outward so that the headlight can be horizontally balanced.

2. Description of the Prior Art Commonly, conventional vehicle headlights may beam in an oblique angle owing to different weight of passengers sitting in a car to force the headlights unable to be positioned horizontally.

### SUMMARY OF THE INVENTION

The object of this invention is to offer a step motor able to adjust vehicle a headlight's up or down so that the lighting angle of the head-light can be beaming horizontally.

The step motor includes a supporting pole, a magnet, a coil and a circuit board. The circuit board has a power input terminal subsequently connected with a voltage regulator IC, a control IC, a transistor and a driver. In addition, the driver is connected with the coil; the control IC is connected with a signal input terminal further connected with a vehicle compute; the power input terminal is connected with a vehicle power source.

### BRIEF DESCRIPTION OF DRAWINGS

This invention is better understood by referring to the accompanying drawings, wherein:

FIG. 1 is a cross-sectional view of a preferred embodiment of a step motor used to adjust a headlight's up or down in the present invention, showing it being adjusted to a level position;

FIG. 2 is a flow chart of the preferred embodiment of the step motor in the present invention;

FIG. 3 is a circuit diagram of the preferred embodiment of the step motor in the present invention;

FIG. 4 is a cross-sectional view of the preferred embodiment of a step motor used to adjust a headlight facing downward in the present invention; and

FIG. 5 is a cross-sectional view of the preferred embodiment of a step motor used to adjust a headlight facing upward in the present invention.

### DETAILED DESCRIPTION OF THE PREFERRED EMBODIMENT

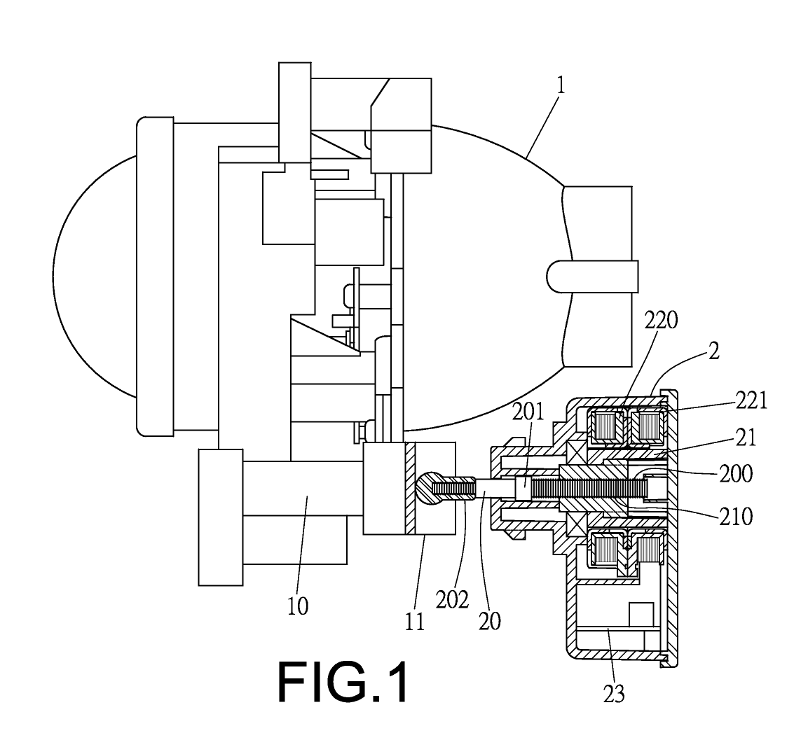

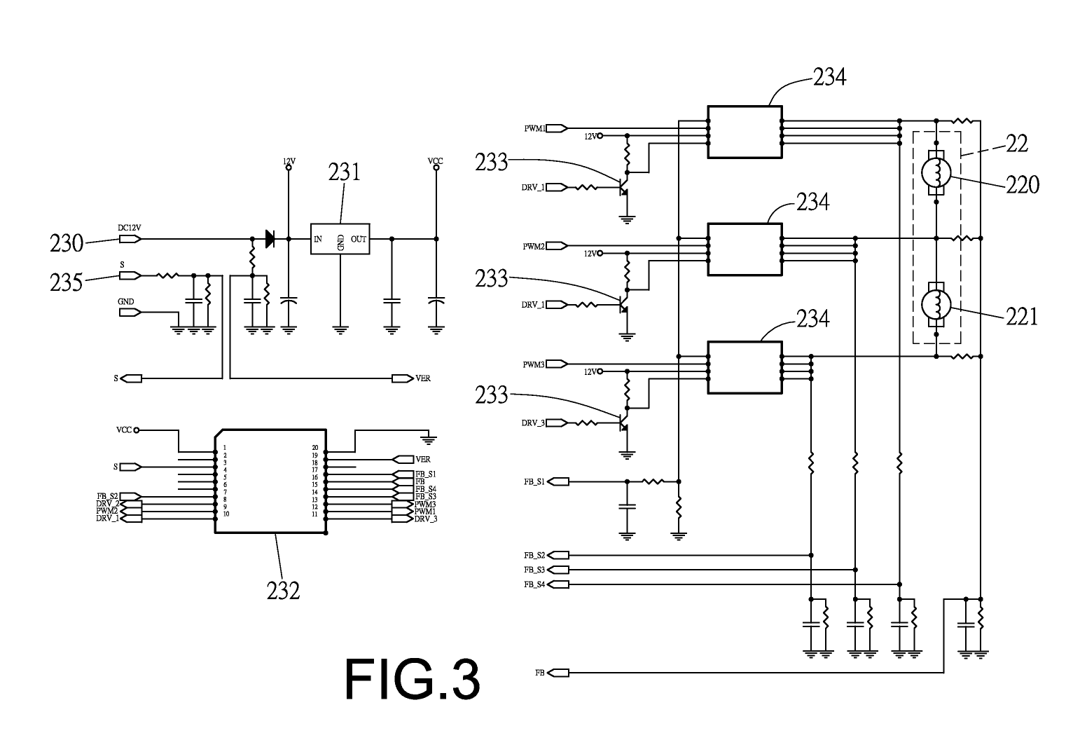

As shown in FIGS. 1-3, a preferred embodiment of a step motor used to adjust a headlight's up and down in the present invention includes a headlight 1 and a step motor 2. The headlight 1 possesses a projected bar 10 that is extended outward at one side and provided with a clamping member 11 formed at one end for fitting with a supporting pole 20 of the step motor 2. The step motor 2 is provided with the supporting pole 20, a magnet 21, a coil 22 and a circuit board 23. The supporting pole 20 is provided with male threads 200 threaded around a bottom portion, a polygonal positioning block 201 located at an intermediate portion, and a supporting member 202 formed at a top portion. The magnet 21 is threaded with female threads. The coil 22 includes a positive coil 220 and a negative coil 221. The circuit board 23 has a power input terminal 230 connected with a voltage regulator IC 231 that is subsequently connected with a control IC 232, a transistor 233 and a driver 234. In addition, the driver 234 is connected with the coil 22; the control IC 232 is connected with a signal input terminal 235 further connected with a vehicle computer 3; the power input terminal 230 is connected with a vehicle power source 4.

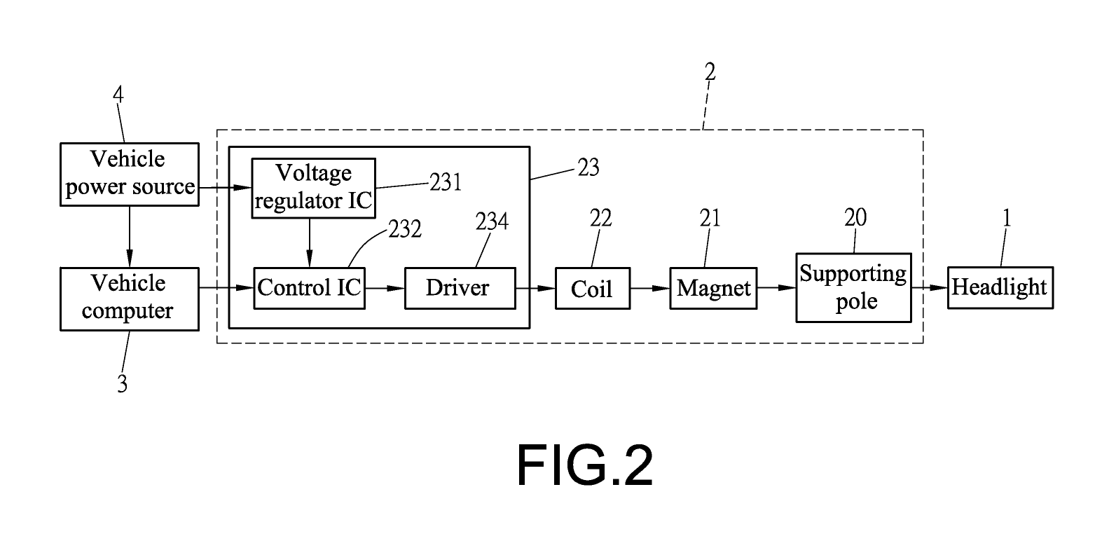

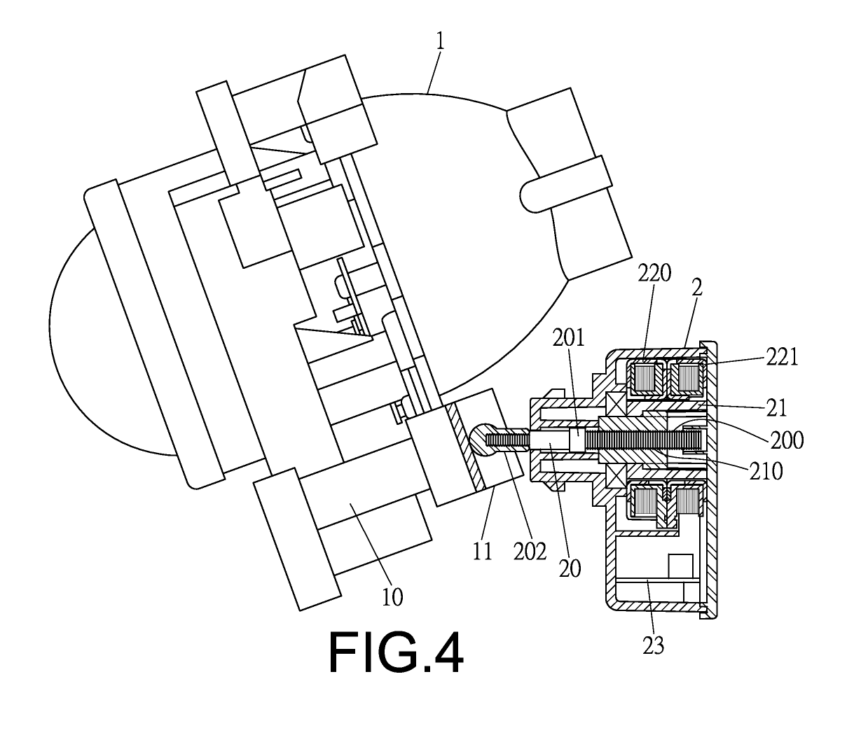

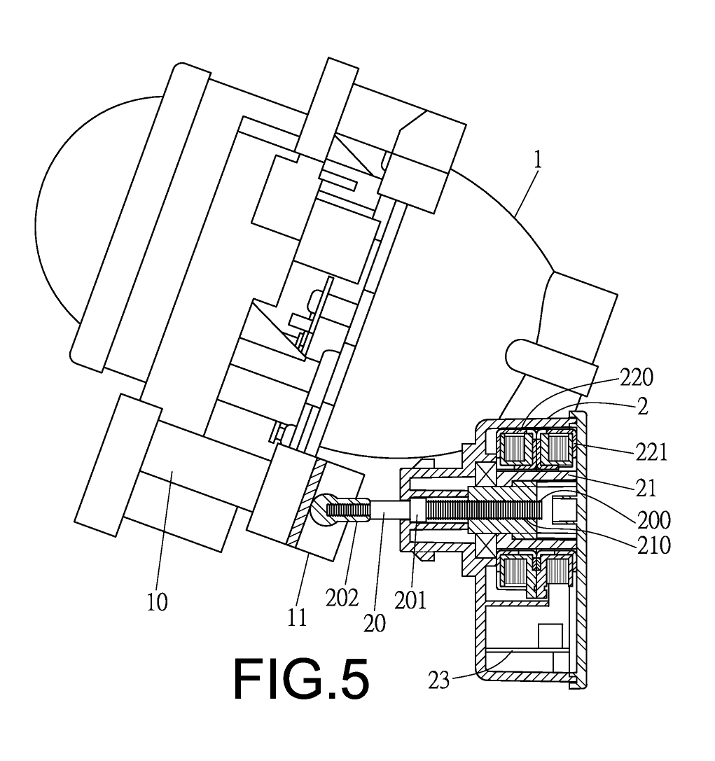

In using, as shown in FIGS. 2-4, when a vehicle is started, power of the vehicle power source 4 can be transmitted from the power input terminal 230 to the voltage regulator IC 231 regulating voltage. Then it runs through the control IC 232 to command the driver 234 to drive the negative coil 221 to create an electric field to induce the magnet 21 to rotate counterclockwise. And with the polygonal positioning block 201 preventing the supporting pole 20 from rotating with the magnet 21, only the male threads 200 of the supporting pole 20 can harmoniously work with rotation of the female threads 210 of the magnet 21, enabling the supporting pole 20 to move inward until the polygonal positioning block 201 is blocked by an outer wall of the step motor 2. By the time, the headlight 1 is turned down with an angle maximally lowered, as shown in FIG. 4. Next, the control IC 232 is to command the driver 234 to drive the positive coil 220 to create an electric field to induce the magnet 21 to rotate clockwise. Also with the polygonal positioning block 201 preventing the supporting pole 20 from rotating with the magnet 21, only the male threads 200 of the supporting pole 20 can harmoniously work with the female threads 210 of the magnet 21, enabling the supporting pole 20 to move outward until the polygonal positioning block 201 is blocked by an inner wall of the step motor 2. By the time, the headlight 1 is turned upward with an angle maximally lifted, as shown in FIG. 5. Finally, the control IC 232 is to command the driver 234 to drive the negative coil 221 to create an electric field to induce the magnet 21 to rotate counterclockwise. With the polygonal positioning block 201 preventing the supporting pole 20 from rotating with the magnet 21, only the male threads 200 of the supporting pole 20 can harmoniously work with the female threads 210 of the magnet 21, enabling the supporting pole 20 to move inward until the headlight 1 is turned down to position at a horizontal level, as shown in FIG. 1. If the headlight 1 illuminates in an oblique angle due to weight unbalance of passengers sitting in a car, the vehicle computer 3 is to immediately send signals through the signal input terminal 235 to the control IC 232, commanding the driver 234 to drive the coil 22 to create an electric field to induce the magnet 21 to rotate clockwise or counterclockwise, so as to enable the supporting pole 20 to move inward or outward until the headlight 1 is horizontally leveled.

While the preferred embodiment of the invention has been described above, it will be recognized and understood that various modifications may be made therein and the appended claims are intended to cover all such modifications that may fall within the spirit and scope of the invention.

What is claimed is:

1. A step motor used to adjust a headlight's up and down, said step motor comprising:
a supporting pole;
a magnet;
a coil;
a circuit board provided with a power input terminal consecutively connected with a voltage regulator IC and a control IC and a transistor and a driver, said driver connected with said coil, said control IC connected with a signal input terminal which is connected with a vehicle computer, said power input terminal connected with a vehicle power source; and
said step motor characterized by transmitting power from said power source through said voltage regulator IC to said control IC that is to command said driver to drive said coil to create an electric field enabling said magnet to rotate clockwise or counterclockwise, so that said supporting pole is to be moved inward or outward to adjust a headlight's up and down until it is balanced horizontally.

2. The step motor as claimed in claim 1, wherein said supporting pole is provided with male threads formed around a bottom portion, a polygonal positioning block located at an intermediate portion of said supporting pole, a supporting member formed at a top portion of said supporting pole.

3. The step motor as claimed in claim 1, wherein said magnet is threaded with female threads.

4. The step motor as claimed in claim 1, wherein said coil includes a positive coil and a negative coil.
